(19) United States
(12) Patent Application Publication
(10) Pub. No.: US 2020/0126051 A1
(43) Pub. Date: Apr. 23, 2020

(54) Micro Funding Methods

(71) Applicant: James Collier, Oakland, CA (US)

(72) Inventor: James Collier, Oakland, CA (US)

(21) Appl. No.: 16/658,956

(22) Filed: Oct. 21, 2019

Related U.S. Application Data
(60) Provisional application No. 62/749,428, filed on Oct. 23, 2018.

(51) Int. Cl. G06Q 20/10; G06Q 40/02; G06Q 20/40; G06Q 20/04; G06Q 20/20

(52) U.S. Cl. CPC G06Q 20/10; G06Q 40/02; G06Q 20/20; G06Q 20/04; G06Q 20/40

(57) ABSTRACT

The methods of the present invention involve the novel use of the credit represented by a valid credit card and the processes of a Payment Network, enabling the credit card holder (CCH) to obtain relatively small, short-term funds at a significantly lower cost than traditionally associated with such funding.

### FIELD OF THE INVENTION

The present invention relates to commercial methods of financing relatively small, short-term fund amounts.

### DISCUSSION OF THE BACKGROUND

Prior art methods for financing relatively small, short term funds are generally perceived to involve substantial risk which demands high costs to the entity seeking such funding.

### BRIEF SUMMARY OF THE INVENTION

The methods of the present invention involve the novel use of the credit represented by a valid credit card and the processes of a Payment Network, enabling the credit card holder (CCH) to obtain relatively small, short-term funds at a significantly lower cost than traditionally associated with such funding. In the methods, CCH provides a Funder with a credit card payment with which the Funder obtains an Authorized Conditional Payment from a Payment Network. The Funder withholds submitting the Authorized Conditional Payment for settlement for a period of time during which the CCH can repay the funds and have the Funder void the Authorized Conditional Payment to avoid the high fees associated with the Funder submitting the Authorized Conditional Payment for settlement.

### Definitions

For convenience of understanding and economy of text, the various embodiments of the disclosed methods as used herein, the following terms are to be understood to have the following meanings:

Credit Card: instrument of credit issued by a bank (“Issuing Bank”) which upon presentation to a merchant and receipt by the merchant of a credit card Authorized Conditional Payment from a Payment Network is accepted by the merchant as payment for goods and services.
Authorized Conditional Payment: a right of a merchant to be paid the amount of the Authorized Conditional Payment upon its submission for settlement to a Payment Network within a specified period of time. If not submitted within the specified period of time, the Authorized Conditional Payment automatically expires and is voided. An Authorized Conditional Payment is typically valid for a fixed number of days (“Authorized Conditional Payment Time Period”).
Authorized Conditional Payment Time Period: the period of time during which an Authorized Conditional Payment is valid for settlement. Typically, but not necessarily, seven or more days.
Credit Card Holder (“CCH”): an individual or entity that has been issued a credit card by an Issuing Bank.
Credit Card Holder's Bank (“CCHB”): a bank with which the CCH has an established active bank account (“Credit Card Holder's Bank Account”).
Merchant: a provider of goods and/or services that accepts as payment an Authorized Conditional Payment from the Payment Network.
Payment Network: inter alia, an Issuing Bank, an Acquiring Bank, and Payment Processors that processes, in part or whole, tendered credit card payments, including determining if a submitted request for an Authorized Conditional Payment qualifies to be issued and, if so, issuing it.
Requested Funds: funds requested by CCH.
Deposited Funds: the amount of funds deposited into CCH's Bank Account by Funder.
Repayment Funds: the amount of funds to be repaid to Funder by CCH.
Repayment Funds Time Period: a number of days less than the Authorized Conditional Payment Time Period.
Credit Card Funds: the amount of the tendered credit card payment which includes the deposited funds plus fees.
Funder: a merchant that accepts a credit card Authorized Conditional Payment in exchange for depositing funds in the Credit Card Holder's Bank Account.
Fixed Fee: the cost to the CCH for the deposited funds.
Conditional Fee: a fee included in the Credit Card Funds which is collected only if the Funder does not receive timely payment of Repayment Funds from the CCH and submits the Authorized Conditional Payment to Payment Processor for settlement.

### SUMMARY OF THE INVENTION

A Funder, relying on the security of a credit card Authorized Conditional Payment for Credit Card Funds, deposits deposited funds into CCH's bank account. Funder withholds submitting the Authorized Conditional Payment for a period less than the Authorized Conditional Payment Time Period before submitting it for settlement. If the Funder timely receives the Repayment Funds from CCH before expiration of the Repayment Funds Time Period, Funder causes the Authorized Conditional Payment to be voided.

If Funder fails to receive the Repayment Funds from CCH before expiration of the Repayment Funds Time Period, Funder submits the Authorized Conditional Payment to the Payment Network for settlement.

### BRIEF DESCRIPTION OF DRAWINGS

FIG. 1 is an annotated flow chart of the various steps of the described novel methods.

FIG. 2 is an annotated flow chart of a server network for performing the steps of the described network.

### DETAILED DESCRIPTION OF INVENTION

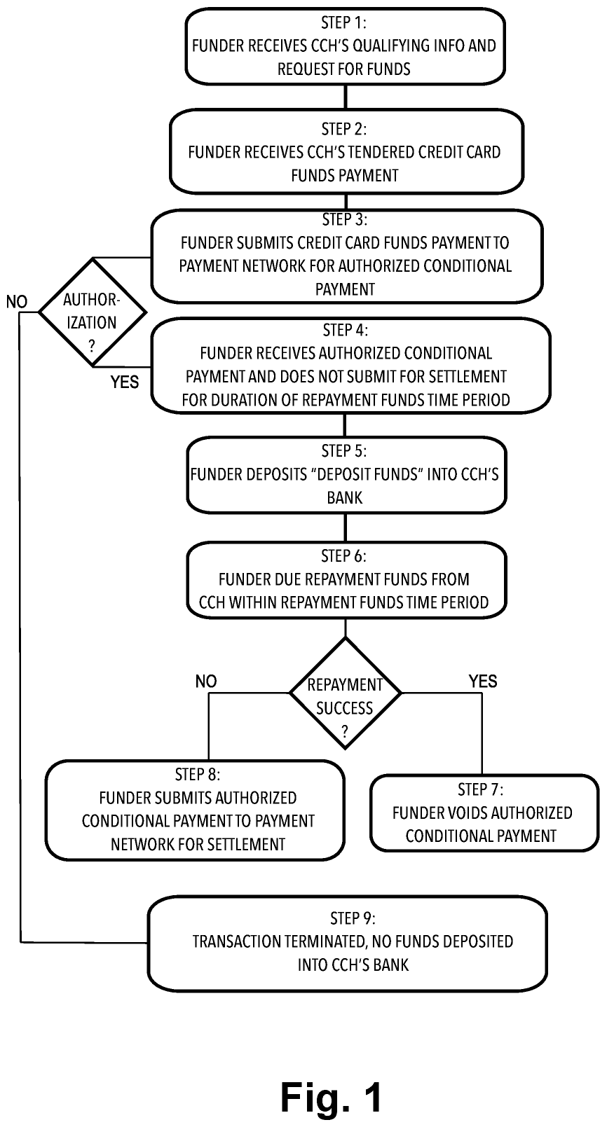

Referring to FIG. 1:

Step 1: In one embodiment of the method, Funder receives qualifying information from CCH and a request for funds (“Requested Funds”). With CCH's request for Requested Funds, Funder may also receive some or all of the following information: (a) CCH's credit card information (e.g., issuer of card, name on card, card number, expiration date and CV number); (b) CCH's Bank Account information sufficient for Funder to deposit funds into CCH's Bank Account; (c) CCH's automatic deposit of funds into its Bank Account information; (d) a signed authorization from CCH to withdraw funds from CCH's Bank Account.

Regarding fees, there are at least two classes of fees. A Fixed Fee that is mandatory and must be paid and a Conditional Fee that is always added to the Credit Card Funds but only collected by Funder if Funder does not receive Repayment Funds from CCH within the Repayment Funds Time Period and Funder is required to submit the Authorized Conditional Payment to the Payment Network for settlement.

In one embodiment, the amount of the Credit Card Funds will include the Deposited Funds, plus a Conditional Fee, plus a Fixed Fee. In that embodiment, the Repayment Funds will equal the Deposited Funds plus the Fixed Fee.

In another embodiment, the amount of the Credit Card Funds will include the Deposited Funds plus a Conditional Fee. In that embodiment, the Deposited Funds equals the Requested Funds minus the Fixed Fee.

In the first above mentioned embodiment, the Deposited Funds is the Requested Funds. The amount of the Repayment Funds is the Requested Funds plus the Fixed Fee.

In the second mentioned embodiment, the amount of the Deposited Funds is the Requested Funds, minus the Fixed Fee, and the amount of the Repayment Funds is the amount of the Requested Funds.

It will be understood by those skilled in the art that other and different fees can be imposed without departing from the scope of the invention.

Step 2: Funder receives CCH's tendered credit card payment for Credit Card Funds in an amount described above in connection with Step 1, depending on the embodiment of the method.

Step 3: Funder submits CCH's tendered credit card payment to a Payment Network for an Authorized Conditional Payment. If Funder is issued an Authorized Conditional Payment, Funder proceeds to step 4; if Funder does not receive an Authorized Conditional Payment from the Payment Network, Funder terminates the process and no funds are deposited into CCH's Bank Account.

Step 4: Funder deposits Deposited Funds into CCH's Bank Account. The amount of the Deposited Funds is either the amount of the Requested Funds or the amount of the Requested Funds minus the amount of the Fixed Fee, depending on the embodiment of the method.

The Authorized Conditional Payment Time Period can vary, but typically it is between seven and thirty days from issuance. Thus, the Repayment Funds Time Period will be dependent the Authorized Conditional Payment Time Period and, in no event, greater than the Authorized Conditional Payment Time Period.

Step 5: If Funder receives the full amount of the Repayment Funds from CCH within the Repayment Funds Time Period, Funder proceeds to Step 6. These funds may be received directly from CCH, or in the embodiment where Funder receives an authorization to withdraw funds from CCH's Bank Account, by use of that authorization or otherwise. The invention is not limited by how Funder receives Repayment Funds from CCH.

If Funder does not receive Repayment Funds from CCH within the Repayment Funds Time Period, Funder performs step 7.

Step 6: Funder voids the Authorized Conditional Payment.

Step 7: Funder submits the Authorized Conditional Payment to the Payment Network for settlement.

It will occur to those skilled in the art that the method described above can be carried out entirely by a “Client” using an app and servers of Funder and the various other stakeholders.

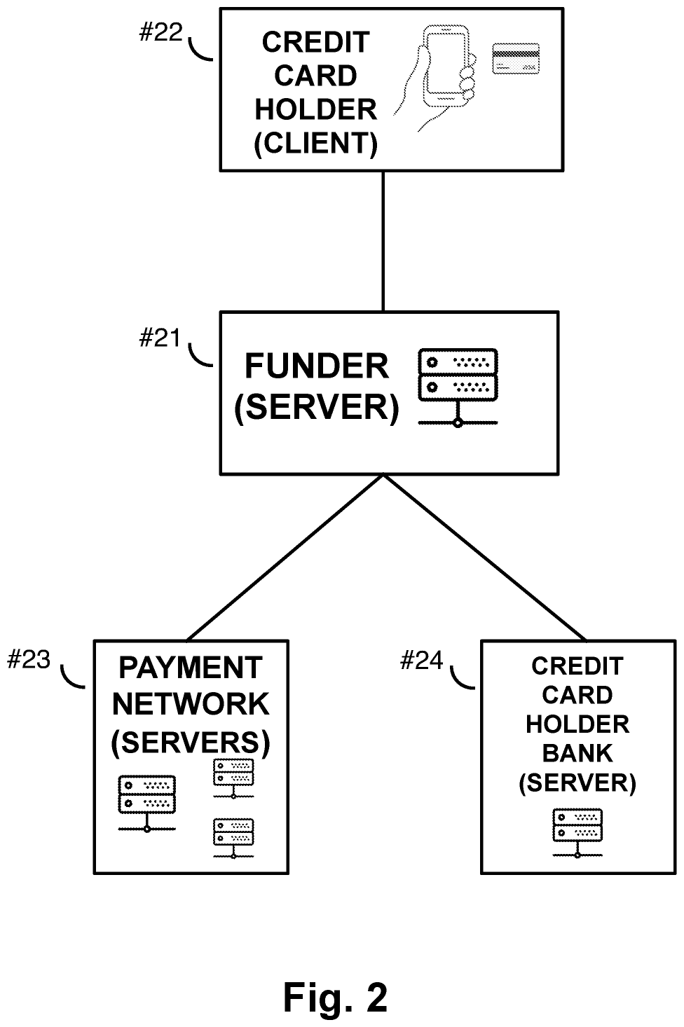

Referring to FIG. 2, the Funder server 21 prompts the Client App 22 to receive all or some of the information from CCH specified in Step 1 above.

If Funder server 21 qualifies CCH for the Specified Funds, Funder server 21 prompts Client App 22 to receive a credit card payment from CCH in the amount of the Credit Card Funds.

Funder server 21 submits the credit card payment to the Payment Network servers 23 for a Conditional Authorization Payment of the Credit Card Funds.

Funder server 21 does not receive the Conditional Authorization Payment, the transaction is terminated and no funds are deposited into CCH's Bank Account.

If Funder server 21 receives a Conditional Authorization Payment from the Payment Network 23 for the Credit Card Funds, Funder server 21 deposits Deposit Funds into CCH's Bank Account by way of CCH's Bank server.

If Funder server 21 receives payment from CCH, Funder server 21 voids the Conditional Authorization Payment.

If Funder server 21 does not receive payment from CCH, Funder server 21 submits the Conditional Authorization Payment to the Payment Network server 23 for settlement.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. In a funding process by which a Funder provides funds to a CCH, where the CCH has a valid credit card and an active Bank Account, the steps comprising:
Funder receiving an application including qualifying information for Requested Funds from CCH;
Funder receiving CCH's Credit Card Funds as tendered payment for the Requested Funds wherein the Credit Card Funds may include a Fixed Fee and/or a Conditional Fee;
Funder obtaining an Authorized Conditional Payment from a Payment Network in an amount of the Credit Card Funds wherein the Authorized Conditional Payment has an Authorized Conditional Payment Time Period;
Funder depositing Deposited Funds into CCH's Bank Account;
Funder withholding submitting the Authorized Conditional Payment for a Repayment Funds Time Period which is less than the Authorized Conditional Payment Time Period before submitting the Authorized Conditional Payment for settlement.

2. The process of claim 1 wherein Funder receives Repayment Funds from CCH within a Repayment Funds Time Period, and further comprising:
Funder causing the Authorized Conditional Payment to be voided.

3. The process of claim of claim 1 wherein Funder does not receive Repayment Funds from CCH prior to the expiration of the Repayment Funds Time Period; and further comprising:
Funder submitting the Authorized Conditional Payment to a Payment Network for settlement prior to the expiration of the Authorized Conditional Payment Time Period.

4. The process of claim 1 wherein qualifying information includes one or more periodic deposits regularly made into CCH's bank account; CCH's bank deposit information; CCH authorization to withdraw funds from CCH's bank account.

5. The process of claim 1 wherein the Credit Card Funds include the amount of the Requested Funds, a Fixed Fee and a Conditional Fees.

6. The process of claim 3 wherein the amount of the Deposited Funds is the amount of the Requested Funds; and the Repayment Funds is the sum of the Requested Funds and a Fixed Fee.

7. The process of claim 1 wherein the amount of the Credit Card Funds is the Requested Funds and a Conditional Fee, and the amount of the Authorized Conditional Payment is the sum of the Requested Funds and a Conditional Fee.

8. The process of claim 5 wherein the amount of the Deposited Funds is the amount of the Requested Funds minus the amount of a Fixed Fee, and the Repayment Funds is the amount of the Requested Funds.

9. The process of claim 7, further comprising:
Funder receiving authorization from CCH to withdraw repayment funds from CCH's Bank Account within the Repayment Funds Time Period; and
Funder submitting to CCH's Bank the authorization to withdraw Repayment Funds from CCH's Bank Account.

10. The process of claim of claim 1 wherein the method steps are carried out by a CCH App and servers.
